(19) United States
(12) Patent Application Publication
(10) Pub. No.: US 2026/0235816 A1
(43) Pub. Date: Aug. 13, 2026

(54) OPTICAL MODULE RECEIVING-END OPTICAL STRUCTURE

(71) Applicant: BLOVELIGHT (GUANGDONG) INTELLIGENT TECHNOLOGY CO., LTD, Dongguan (CN)

(72) Inventors: Wei ZHAO, Xingwen (CN); Dawei GUO, Baokang (CN)

(21) Appl. No.: 19/242,027

(22) Filed: Jun. 18, 2025

(30) Foreign Application Priority Data
Feb. 13, 2025 (CN) 2025200713553

(51) Int. Cl. G02B 6/38; G02B 6/36; G02B 6/40

(52) U.S. Cl. CPC G02B 6/3853; G02B 6/3644; G02B 6/403

(57) ABSTRACT

The present disclosure discloses an optical module receiving-end optical structure, including a lens body and a ferrule body, where a plurality of PD chips are disposed below the lens body; the ferrule body is provided with a plurality of optical fiber insertion holes for inserting optical fibers, with a front end face of the ferrule body being an inclined plane with a top protruding forward; a rear end of the lens body is provided with a rear recess, with a plurality of rear lens portions disposed at a bottom of the rear recess; and the lens body includes a total reflection surface, with a plurality of lower lens portions disposed on the lens body below the total reflection surface.

### CROSS-REFERENCE TO RELATED APPLICATION

This application claims priority from the Chinese patent application 2025200713553 filed Jan. 13, 2025, the content of which is incorporated herein in the entirety by reference.

### Technical Field

The present disclosure relates to an optical signal transmission device, and in particular to an optical module receiving-end optical structure.

### Background Art

An optical signal transmission device, as a laser communication component, is typically applied in high-speed optical modules and belongs to the core components of optical communication systems. The schematic diagram of the optical path thereof is shown in FIG. 7, and the working principle is as follows: laser transmitted through an optical fiber is collimated by a plastic lens or a glass lens, then reflected, and subsequently focused onto a light-receiving PD chip. The PD chip and an electrical chip then convert the optical signal into an electrical signal, which is subsequently subjected to signal analysis, thereby achieving the reception of the optical signal. However, the existing optical transmission devices have the following defects: Firstly, such optical modules exhibit low return loss and high bit error rates, leading to easy packet loss during communication. Meanwhile, the requirement for the reflectivity of the coating on the chip surface is high, but the reflectivity of the chip surface cannot be directly measured, which is unfavorable for production control. In addition, the current optical module structures require two processed glass sheets to press multiple optical fibers, followed by adhesive fixing, and then grinding treatment. The complex process leads to higher product costs.

### SUMMARY

The technical problem to be solved by the present disclosure is to provide an optical module receiving-end optical structure that can effectively increase the return loss while having a simple structure and reduced costs, in view of the deficiencies in the prior art.

To solve the above technical problem, the present disclosure adopts the following technical solution.

An optical module receiving-end optical structure, including a lens body and a ferrule body, where the lens body is disposed at a front end of the ferrule body and the two are fitted through insertion, with a plurality of PD chips disposed below the lens body; the ferrule body is provided with a plurality of optical fiber insertion holes for inserting optical fibers, a front end face of the ferrule body being an inclined plane with a top protruding forward, and front end faces of the optical fibers being flush with the front end face of the ferrule body; a rear end of the lens body is provided with a rear recess, with a plurality of rear lens portions disposed at a bottom of the rear recess, the rear lens portions being aligned one-to-one with end faces of the optical fibers; and the lens body includes a total reflection surface, with a plurality of lower lens portions disposed on the lens body below the total reflection surface, the lower lens portions being in one-to-one correspondence with the PD chips, where optical signals emitted from the optical fibers pass through the rear lens portions and are transmitted to the total reflection surface, and the optical signals reflected by the total reflection surface pass through the lower lens portions and are transmitted to the PD chips.

Preferably, a rear end face of the lens body is an inclined plane, and the rear end face of the lens body abuts against the front end face of the ferrule body.

Preferably, two insertion posts extending in the front-to-back direction are formed at the rear end of the lens body, and two insertion holes extending in the front-to-back direction are provided in the ferrule body, where the insertion posts are in one-to-one correspondence with the insertion holes, and the insertion posts are inserted into and tightly fitted with the insertion holes.

Preferably, a rear end of the ferrule body is provided with a fixing opening, and the optical fiber insertion holes are provided on a front side wall of the fixing opening, with adhesive being provided within the fixing opening.

Preferably, a step portion is provided within the fixing opening, with a plurality of accommodating grooves provided on the step portion, the accommodating grooves being in one-to-one correspondence with the optical fiber insertion holes.

Preferably, a flared portion is formed at a rear end of the optical fiber insertion hole.

Preferably, a top of the lens body is provided with an upper groove, with the total reflection surface being formed at a bottom of the upper groove.

In the optical module receiving-end optical structure disclosed in the present disclosure, the lens body and the ferrule body are sequentially arranged in the front-to-back direction, and the two can be assembled by means of insertion. At the same time, the rear lens portions are aligned one-to-one with the end faces of the optical fibers. When the optical fibers emit laser signals, the laser signals pass through the rear lens portions and are transmitted to the total reflection surface. The laser signals are then reflected by the total reflection surface to the lower lens portions, and finally pass through the lower lens portions and are transmitted to the PD chips. Compared with the prior art, in the present disclosure, after the optical signals emitted by the optical fibers are incident to the lens body, they are directed obliquely at a certain angle onto the PD chips, thereby achieving the purpose of optimizing the return loss. Additionally, the present disclosure features a simple structure, convenient assembly, and lower application costs.

### BRIEF DESCRIPTION OF THE DRAWINGS

FIG. 1 is a first perspective view of an optical module receiving-end optical structure according to the present disclosure;

FIG. 2 is a second perspective view of an optical module receiving-end optical structure according to the present disclosure;

FIG. 3 is a first exploded view of an optical module receiving-end optical structure according to the present disclosure;

FIG. 4 is a second exploded view of an optical module receiving-end optical structure according to the present disclosure;

FIG. 5 is a cross-sectional view of an optical module receiving-end optical structure according to the present disclosure;

FIG. 6 is a schematic diagram of an optical path of an optical module receiving-end optical structure according to the present disclosure; and

FIG. 7 is a schematic diagram of an optical path of an existing optical module.

### DETAILED DESCRIPTION OF EMBODIMENTS

The present disclosure will be described in more detail below in conjunction with the accompanying drawings and embodiments.

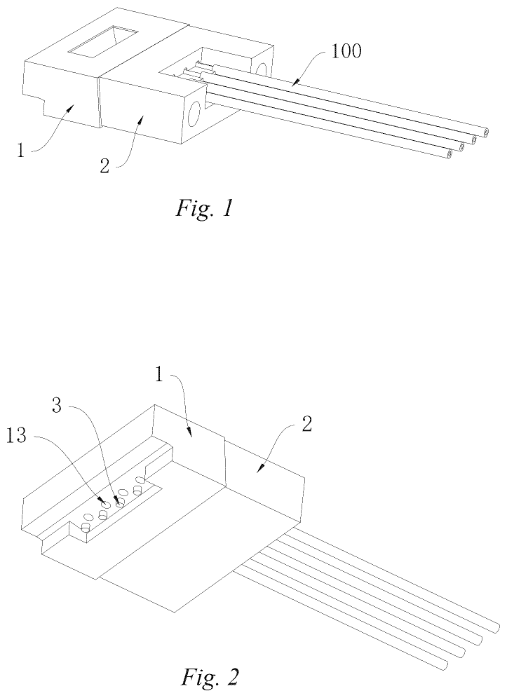

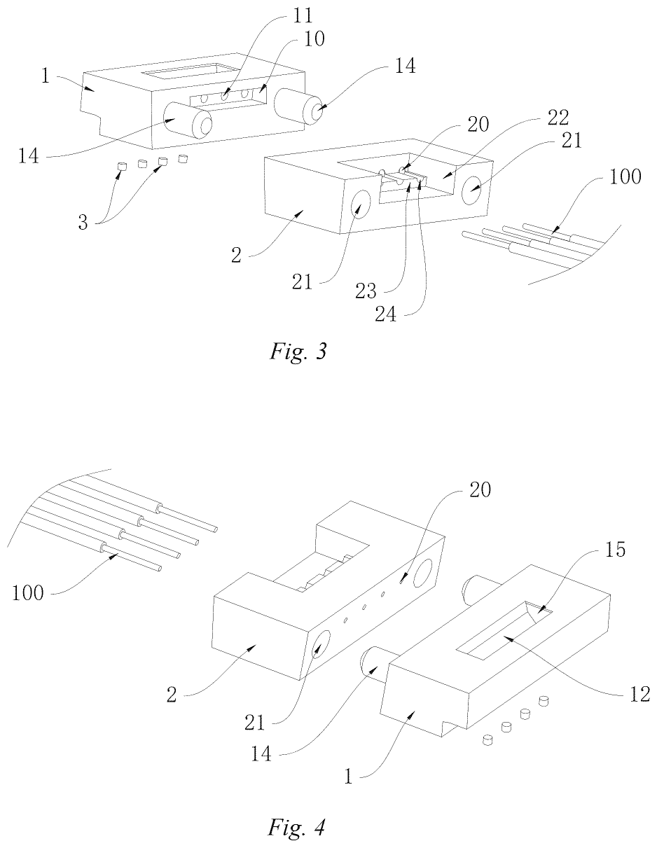

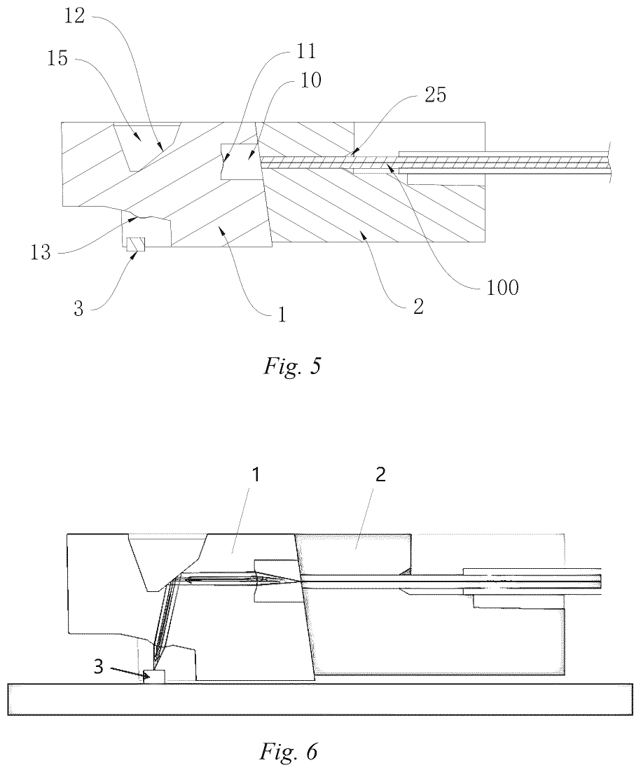

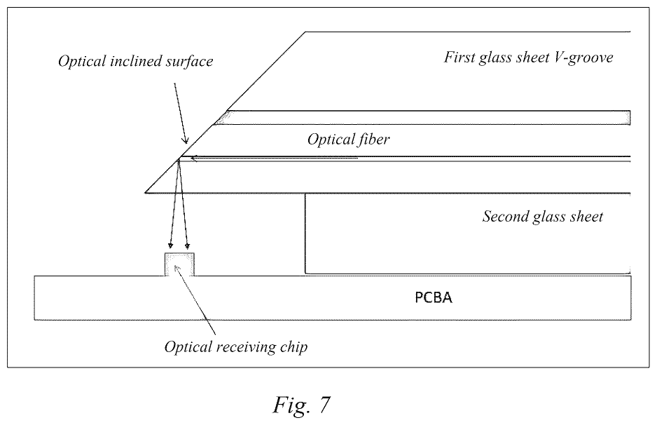

The present disclosure discloses an optical module receiving-end optical structure which, as shown in FIGS. 1 to 6, includes a lens body 1 and a ferrule body 2, where the lens body 1 is disposed at a front end of the ferrule body 2 and the two are fitted through insertion, with a plurality of PD chips 3 disposed below the lens body 1; the ferrule body 2 is provided with a plurality of optical fiber insertion holes 20 for inserting optical fibers 100, a front end face of the ferrule body 2 being an inclined plane with a top protruding forward, and front end faces of the optical fibers 100 being flush with the front end face of the ferrule body 2; a rear end of the lens body 1 is provided with a rear recess 10, with a plurality of rear lens portions 11 disposed at a bottom of the rear recess 10, the rear lens portions 11 being aligned one-to-one with end faces of the optical fibers 100; and the lens body 1 includes a total reflection surface 12, with a plurality of lower lens portions 13 disposed on the lens body 1 below the total reflection surface 12, the lower lens portions 13 being in one-to-one correspondence with the PD chips 3, where optical signals emitted from the optical fibers 100 pass through the rear lens portions 11 and are transmitted to the total reflection surface 12, and the optical signals reflected by the total reflection surface 12 pass through the lower lens portions 13 and are transmitted to the PD chips 3.

In the aforementioned structure, the lens body 1 and the ferrule body 2 are sequentially arranged in the front-to-back direction, and the two can be assembled by means of insertion. At the same time, the rear lens portions 11 are aligned one-to-one with the end faces of the optical fibers 100. When the optical fibers 100 emit laser signals, the laser signals pass through the rear lens portions 11 and are transmitted to the total reflection surface 12. The laser signals are then reflected by the total reflection surface 12 to the lower lens portions 13, and finally pass through the lower lens portions 13 and are transmitted to the PD chips 3. Compared with the prior art, in the present disclosure, after the optical signals emitted by the optical fibers are incident to the lens body 1, they are directed obliquely at a certain angle onto the PD chips 3, thereby achieving the purpose of optimizing the return loss. Additionally, the present disclosure features a simple structure, convenient assembly, and lower application costs.

To make the lens body 1 and the ferrule body 2 fit more tightly in the front-to-back direction, in this embodiment, a rear end face of the lens body 1 is an inclined plane, and the rear end face of the lens body 1 abuts against the front end face of the ferrule body 2.

Regarding the preferred insertion fitting between the lens body 1 and the ferrule body 2, in this embodiment, two insertion posts 14 extending in the front-to-back direction are formed at the rear end of the lens body 1, and two insertion holes 21 extending in the front-to-back direction are provided in the ferrule body 2, where the insertion posts 14 are in one-to-one correspondence with the insertion holes 21, and the insertion posts 14 are inserted into and tightly fitted with the insertion holes 21.

In the aforementioned structure, based on the insertion fitting effect between the two insertion posts 14 and the two insertion holes 21, the technical problem of the lens body 1 and the ferrule body 2 being difficult to align in the front-to-back direction is resolved. At the same time, based on the fitting effect between the inclined surface of the rear end of the lens body 1 and the inclined surface of the front end of the ferrule body 2, the lens body 1 and the ferrule body 2 can be more reliably combined together, thereby ensuring the accurate transmission of optical signals. In addition, this embodiment can effectively maximize the return loss of the optical fibers per se.

As a preferred implementation, a rear end of the ferrule body 2 is provided with a fixing opening 22, and the optical fiber insertion holes 20 are provided on a front side wall of the fixing opening 22, with adhesive being provided within the fixing opening 22. The adhesive filled in the fixing opening 22 serves to fix a plurality of optical fibers 100.

To assist in positioning the optical fibers 100, in this embodiment, a step portion 23 is provided within the fixing opening 22, with a plurality of accommodating grooves 24 provided on the step portion 23, the accommodating grooves 24 being in one-to-one correspondence with the optical fiber insertion holes 20.

Furthermore, a flared portion 25 is formed at a rear end of the optical fiber insertion hole 20. In this embodiment, the purpose of providing the flared portion 25 at the rear end of the optical fiber insertion hole 20 is to facilitate the insertion of the optical fiber 100.

As a preferred implementation, a top of the lens body 1 is provided with an upper groove 15, with the total reflection surface 12 being formed at a bottom of the upper groove 15.

The optical module receiving-end optical structure disclosed in the present disclosure can effectively increase the return loss from the perspective of physical structure, thereby reducing the bit error rate of the optical module. Additionally, it can effectively reduce the requirements for the reflectivity of the coating on the surface of the receiving chip PD, thereby significantly lowering application costs. Meanwhile, based on the optical path of this optical design, the focused spot size is small, resulting in a large overall coupling tolerance. Furthermore, this optical path structure requires small modifications to the original product structure, and the newly designed optical path can be well compatible with the original product. In addition, the product of the present disclosure features simple product molding, simplified product assembly processes, and higher yield rates in mass production.

The above description only represents preferred embodiments of the present disclosure and is not intended to limit the present disclosure. Any modifications, equivalent replacements, or improvements made within the technical scope of the present disclosure shall fall within the scope of protection of the present disclosure.

1. An optical module receiving-end optical structure, comprising a lens body and a ferrule body, wherein the lens body is disposed at a front end of the ferrule body and the two are fitted through insertion, with a plurality of PD chips disposed below the lens body; the ferrule body is provided with a plurality of optical fiber insertion holes for inserting optical fibers, a front end face of the ferrule body being an inclined plane with a top protruding forward, and front end faces of the optical fibers being flush with the front end face of the ferrule body; a rear end of the lens body is provided with a rear recess, with a plurality of rear lens portions disposed at a bottom of the rear recess, the rear lens portions being aligned one-to-one with end faces of the optical fibers; and the lens body comprises a total reflection surface, with a plurality of lower lens portions disposed on the lens body below the total reflection surface, the lower lens portions being in one-to-one correspondence with the PD chips, wherein optical signals emitted from the optical fibers pass through the rear lens portions and are transmitted to the total reflection surface, and the optical signals reflected by the total reflection surface pass through the lower lens portions and are transmitted to the PD chips.

2. The optical module receiving-end optical structure of claim 1, wherein a rear end face of the lens body is an inclined plane, and the rear end face of the lens body abuts against the front end face of the ferrule body.

3. The optical module receiving-end optical structure of claim 1, wherein two insertion posts extending in the front-to-back direction are formed at the rear end of the lens body, and two insertion holes extending in the front-to-back direction are provided in the ferrule body, wherein the insertion posts are in one-to-one correspondence with the insertion holes, and the insertion posts are inserted into and tightly fitted with the insertion holes.

4. The optical module receiving-end optical structure of claim 1, wherein a rear end of the ferrule body is provided with a fixing opening, and the optical fiber insertion holes are provided on a front side wall of the fixing opening, with adhesive being provided within the fixing opening.

5. The optical module receiving-end optical structure of claim 4, wherein a step portion is provided within the fixing opening, with a plurality of accommodating grooves provided on the step portion, the accommodating grooves being in one-to-one correspondence with the optical fiber insertion holes.

6. The optical module receiving-end optical structure of claim 1, wherein a flared portion is formed at a rear end of the optical fiber insertion hole.

7. The optical module receiving-end optical structure of claim 1, wherein a top of the lens body is provided with an upper groove, with the total reflection surface being formed at a bottom of the upper groove.
